(19) United States
(12) Patent Application Publication
(10) Pub. No.: US 2019/0108290 A1
(43) Pub. Date: Apr. 11, 2019

(54) HUMAN ASSISTED AUTOMATED QUESTION AND ANSWER SYSTEM USING NATURAL LANGUAGE PROCESSING OF REAL-TIME REQUESTS ASSISTED BY HUMANS FOR REQUESTS OF LOW CONFIDENCE

(71) Applicant: ClinMunications, LLC, Mason, OH (US)

(72) Inventor: Mickey W. Kowitz, Mason, OH (US)

(73) Assignee: ClinMunications, LLC, Mason, OH (US)

(21) Appl. No.: 16/150,307

(22) Filed: Oct. 3, 2018

Related U.S. Application Data
(60) Provisional application No. 62/568,811, filed on Oct. 6, 2017.

(51) Int. Cl. G06F 17/30; H04L 12/58; H04M 3/42; H04M 3/493

(52) U.S. Cl. CPC G06F 17/30976; H04M 3/493; H04M 3/42382; H04L 51/02

(57) ABSTRACT

A call center implementing as a primary facing entry point for customers a text messaging system that allows customers to send a single text message or series of text messages with one or more novel questions that may or may not be formed properly. Instead of a human responding, the system will convert the question to a specific data model and respond via third party extension or directly from the system with a response dynamically answered without being required to be seen by a human prior to responding.

### CROSS REFERENCE TO RELATED APPLICATION

This claims the benefit of U.S. Provisional Patent Application Ser. No. 62/568,811, filed on Oct. 6, 2017, hereby incorporated by reference in its entirety.

### BACKGROUND OF THE INVENTION

This invention is in the technical field of artificial intelligence. More particularly, this invention is in the technical field of natural language processing with both stateful and stateless conversations.

This invention is in the technical field of call centers. More particularly, this invention is in the technical field of utilizing mobile data technology to perform call center activities programmatically. More particularly, this invention is in the technical field of utilizing text messaging and other direct messaging technologies as a gateway to connect to call centers without the necessity of humans directly answering customer questions or customer needs.

Currently call center technology to assist in answering questions is limited to fixed response technology to specific questions without the ability to learn or grow in ability.

### SUMMARY OF THE INVENTION

This invention answers the current problem with the prior art that call centers cannot scale dynamically without manual manipulation of data or exact replication of questions and answers. Typically, the paradigm is technology-assisting humans; whereas, the current invention is humans-assisting technology to enhance models without needing exact questions or answers to fulfill the needs to improve system quality.

This invention includes technology utilizing a pre-processing component that looks at existing text and extrapolates corresponding questions and answers based upon, but not limited to, past call center encounters and other fixed documentation that may or may not be in question and answer format. This invention additionally takes advantage of third party interface structures and dynamically requests data based on calling interfaces from those interface methods. Finally, this invention utilizes human assisted responses to dynamically generate advanced modeling to determine question and answer information.

An example of this invention is a call center implementing as a primary facing entry point for customers a text messaging system that allows customers to send a single text message or series of text messages with one or more novel questions that may be formed properly, or not, and instead of a human responding, the system will convert the question to a specific data model and respond via third party extension or directly from the system with a response dynamically answered without being required to be seen by a human prior to responding.

### BRIEF DESCRIPTION OF THE DRAWINGS

The above-mentioned and other features and advantages of this invention, and the manner of attaining them, will become more apparent and the invention itself will be better understood by reference to the following description of embodiments of the invention taken in conjunction with the accompanying drawings, wherein:

FIG. 1 is a user functional flowchart of one embodiment of this invention;

FIG. 2 is a data setup functional flowchart associated with FIG. 1;

FIG. 3 a block diagram of a user device interacting with an application server of FIG. 1;

FIG. 4 a flowchart illustrating a sequence of operations that may be performed by a processor of FIG. 1;

FIG. 5 is a block diagram of an application that will load web services, the associated data and parameters of the embodiment in FIG. 1;

FIG. 6 is a block diagram of a process that is generally processed by a program code that analyzes the inbound request from the embodiment of FIG. 1;

FIG. 7 is a detailed view of natural language processing integrated in the embodiment of FIG. 1; and

FIG. 8 is a flowchart illustrating an exemplary request handled with modeling data according to one aspect of this invention.

The appended drawings are not necessarily to scale, presenting a somewhat simplified representation of various features illustrative of the basic principles of embodiments of the invention. The specific features consistent with embodiments of the invention disclosed herein, including, for example, specific dimensions, orientations, locations, sequences of operations and shapes of various illustrated components, will be determined in part by the particular intended application, use and/or environment. Certain features of the illustrated embodiments may have been enlarged or distorted relative to others to facilitate visualization and clear understanding.

### DETAILED DESCRIPTION OF THE INVENTION

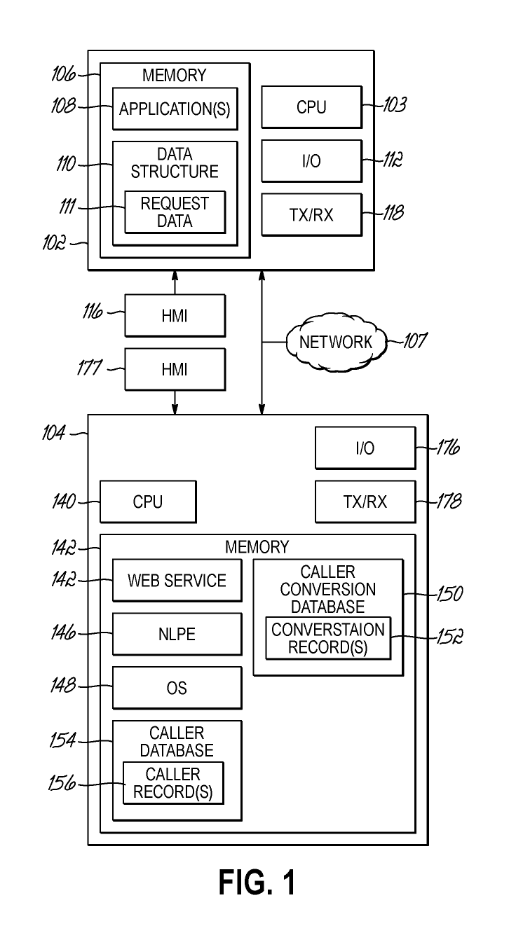

Turning to FIG. 1, a block diagram of a user device 102 and a caller server 104 consistent with embodiments of the invention, where the user device 102 and caller server 104 may be in communication over a communication network 107 is shown. As shown, the user device 102 includes one or more processors (illustrated as ‘CPU’) 103 for executing one or more instructions to perform and/or cause components of the user device 102 to perform one or more operations consistent with embodiments of the invention. The user device 102 includes a memory 106, and at least one application 108 and a data structure 110 stored by memory 106. The data structure may store data for a caller information and memory may load an associated request in, which may be analyzed and responded to by embodiments of the invention to answer questions or provide more questions or operations on the user device 102. User device 102 further includes an input/output (“I/O”) interface 1112, and a human-machine interface (“HMI”) 116 that may or may not be part of the particular embodiment of the invention.

The user request data 111 generally includes internal device-specific data and corresponding conversation request data, including for example a textual question to be answered as it is related to material to be known by the caller server 104. The caller request data 111 may be accessible on the client through any application that can implement it and an associated network protocol that can be transmitted to the caller server where device-specific data can identify the client 102 caller known to those skilled in the art having the benefit of the instant disclosure.

At least one application 108 may generally comprise program code that when executed by the processor 103 facilitates interfacing between a user of the device 102 and the caller server 104.

The memory 106 may represent random access memory (RAM) comprising the main storage of a computer, as well as any supplemental levels of memory, e.g., cache memories, non-volatile or backup memories (e.g., programmable or flash memories), mass storage memory, read-only memories (ROM), etc. In addition, the memory 106 may be considered in various embodiments of this invention to include memory storage physically located elsewhere, e.g., cache memory in a processor of any computing system in communication with the user device 102, as well as any storage device on any computing system in communication with the user device 102 (e.g., a remote storage database, a memory device of a remote computing device, cloud storage, etc.).

The I/O interface 112 of user device 102 may be configured to receive data from input sources and output data from output sources. For example, the IO interface 112 may receive input data from a user input device such as a keyboard, mouse, microphone, touch screen and other such user input device, and the I/O interface 112 may output data to one or more user output devices such as a display (e.g., a computer monitor), a touch screen, speakers, and/or other such output devices that may be used to output data in a format understandable to a user. Such input and output devices are generally represented in FIG. 1 as the human-machine interface (“HMI”) 116. As such, in some embodiments of the invention, user input data may be communicated to the processor 103 of the user device 102 such as a touch screen or keyboard utilizing the HMI interface 116 and the I/O interface 112.

The user device 102 may include a network interface controller (Tx/Rx) 118 that is configured to transmit data over a communications network 107 and/or receive data from the communication network 108. For example, the physical connection between the network 107 and user device 102 may be supplied by a network interface card, an adapter, or a wireless transceiver. As will be described herein, the user device 102 may communicate data over the communication network 107 to thereby interface with the caller server 104, and such interfacing may be controlled by the processor 103 utilizing the network interface controller 118. For example, the processor 103 may execute application 108 which may be a web browser application that is downloaded from the caller server 104 to thereby facilitate interfacing between the user device 102 and the caller server 104. As another example, the processor 103 may execute an application 108 which may be an internal device application that utilizes text messaging that communicates through the carrier network 107 to thereby facilitate interfacing between the user device 102 and the caller server 104.

The caller server 104 may include one or more processors 140 configured to execute instructions to perform one or more operations consistent with embodiments of the invention. The caller server 104 may further include memory 142 accessible by the one or more processors 140. The memory 142 stores one or more applications, including a web service application 144 and/or operating system 146 includes instructions in the form of program code that may be executed by the processor 140 to perform or cause to be performed one or more operations consistent with the embodiments of the invention.

Generally, execution of the web service application 144 and by the processor 140 may cause the caller server 104 to communication with the user device 102 over the communication network 107 to thereby interface with the user device 102. The caller server may receive caller request data from the user using the user device 102 during execution of the web service application 144. After receiving the caller request data, the execution of the AIE 146 may cause the processor 140 to analyze the submitted caller request data and generate the proper caller result data. The executing web service application 144 may cause the processor 140 to interface with the user device 102 to allow the user of the user device 102 to review the caller response data on the user device 102.

The memory 142 of the caller server 104 may include a data structure in the form of a caller conversation database 150 that stores a number of caller conversation records 152. Each caller conversation record 152 corresponds to a particular caller and may store the caller data submitted for analysis, the formatted caller conversation data, a caller identification associated with the caller request, and/or any other such data. Moreover, the memory 142 may further include a data structure in the form of a caller database 154 that stores on or more caller records 156, password and pin for each user, third party connectivity identification data, user device 102 phone number and/or other such information data indicating statistics associated with the caller conversation previously submitted and/or caller conversation data previously answered or requests for the caller identification including for example, previously responses and/or data indicating caller conversation records associated with 152 associated with the caller record 156.

As discussed above with respect to the user device 102, the memory 142 of the caller server 104 may represent local memory and/or remote memory. As such, while the memory 142 is illustrated as one component, the invention is not so limited. In some embodiments, the memory 142 may include remote memory accessible to the processor 140 and located in one or more remote computing systems, including for example, one or more interconnected data servers accessible over one or more communication networks. Hence, while the web service application 144, AIE 146, OS 148, caller conversation database 150, and the caller database 154 are illustrated as located in memory 142 in the caller server 104, in some embodiments, the web services application 144, AIE 146, OS 148, caller conversation database 150 and caller database 154 may be physically located in memory of one or more remote memory locations accessible by the processor 140. The memory 142 may also include a database management system in the form of a computer program that, when executing as instructions on the processor 140, is used to access the information or data stored in the records of the caller conversation database 150 and the caller database 154. The caller conversation database 150 and caller database 154 may be stored in any database organization and/or structure including for example relational databases, hierarchical databases, network databases, and/or combinations thereof.

The caller server 104 may further include an input/output (“I/O”) interface 176, where the I/O interface 176 may be configured to receive data from input sources and output data to output sources. For example, the I/O interface 176 may receive input data from a user input device such as a keyboard, mouse, microphone, touch screen, and other such user input devices, and the I/O interface 176 may output data to one or more user output devices such as a computer monitor, a touch screen, speakers, and/or other such output devices that may be used to output data in a format understandable to a user. Such input and output devices are generally represented in FIG. 1 as an HMI 177. As such, in some embodiments of the invention, input data may be communicated to the processor 140 of the caller server 140 using a user input device such as a keyboard or touch screen utilizing the I/O interface 176. Furthermore, as discussed previously, in some embodiments, the caller server 104 may include a number of interconnected computing devices each located locally or remotely. As such, in these embodiments data may be input to the caller server via an HMI 177 and I/O interface 176 located remote from the computing device including a processor 140 and/or a memory 142. The caller server may include a network interface controller (Tx/Rx) 178, where the data may be transmitted and/or received over the network 108 of FIG. 1 using each network connection device 178. For example, the physical connection between the network 198 and the caller server 104 may be supplied by a network interface card, an adapter or transceiver.

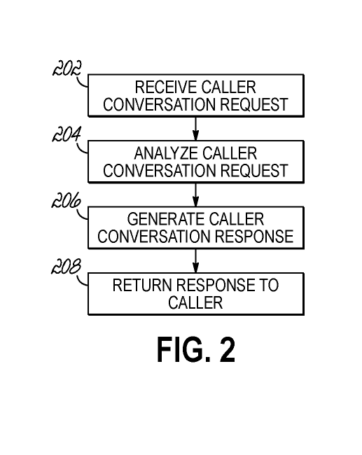

FIG. 2 provides a flowchart 200 that illustrates a sequence of operations that may be performed by the processor 140 of the caller server 104 of FIG. 1 to generate a response consistent with the embodiments of the invention. The caller server 104 receives a caller conversation request from the user device 102 over the communication network 107 (block 202). The caller server 104 analyzes the caller conversation request to determine the proper response to the request (block 204). The caller server generates the correct response to return to the caller based on any third-party data or other data (block 206). The caller server then returns the response to the caller (block 208) through the proper transmission mechanism associated with the request transmission to the user client of 102 of FIG. 1. The corresponding caller conversation data record 152 is stored in caller conversation database 150.

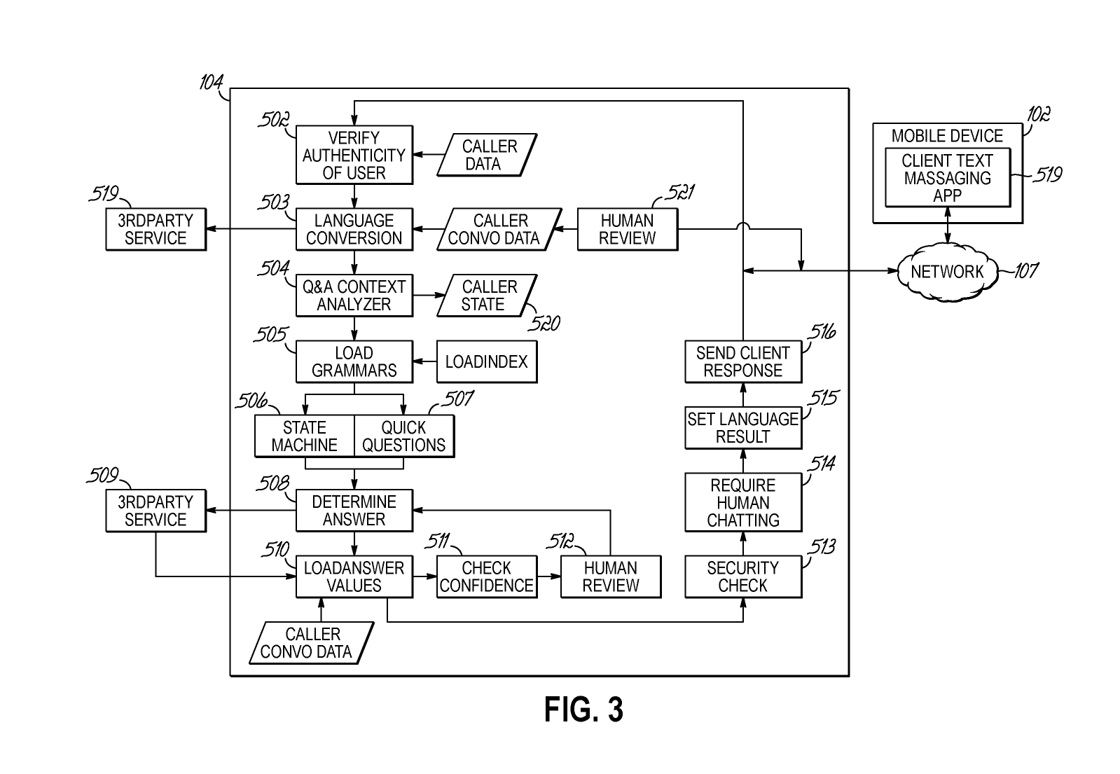

Referring now to one embodiment of the invention in more detail, in FIG. 3 a block diagram of a user device interacting with an application server wherein the user device and device application 102 is interacting with application services server 104 to provide responses based on the current inventions implementation of natural language processing is shown. In 107 the data request from 102 is transmitted to services server 104 in one embodiment by means of, but not limited to, Simple Message Protocol(SMS) or Multi-Media Message Protocol(MMS). The request is then, generally by means of program code, authenticated in 502 and then generally by program code checked for language the request is received in 503. If the language is not English, it may be, but not limited to, sent to a third party 519 for conversion to English. When returned, it will be sent for processing generally by means of program code to steps 504 through 510. In some embodiments of the invention the processor will determine, based on, but not limited to, Parts of Speech tagging in 504 whether the request is a question or statement associated with either an answer or command. The request can be stored in a caller conversation data table record by caller including the information that determined whether the request was a question, answer, statement or command. In the Q&A Context Analyzer 504 the program code will, in this embodiment, be used to determine if the request is a question, by looking at key introductory words such as “who”, “what”, “when”, “where” and “how” or the use of a question mark. If a statement phrase is utilized, it evaluates to see if there is a static and stateless response, such as common phrases like “Hello” where a static response is used. The analyzer 504 will check the caller conversation state data table for the current caller state to see if the conversation is a new conversation, an existing stateful conversation or an existing stateless conversation.

Depending on the state of the current conversation, the program will perform state machine functions or quick question, stateless functions 506 after loading the appropriate grammar 505. Then the processor will load grammar data 505 associated with the current indexed request and state of the request in 520 based on caller information and then in some embodiments the processor will forward the request for processing generally by means of program code to step 506 depending on whether it is a question, answer, statement or command. The Quick Questions process 506 is a handler for stateless questions with answers. The State Machine is the handler for statements or answers to previous questions asked by the caller at FIG. 1 block 102. In some embodiments of the invention, the processor will load answers based on confidently identified questions in 508. The process, generally by means of program code, will load result text and if the data loaded requires a third-party application to provide real-time result information through a third-party transport 509, it will retrieve data. The results will be returned and programmatically inserted into the answer text and loaded into the caller conversation data table record associated with the request generally by means of program code to return the result information to the client application in this embodiment through 513 to 516. In this embodiment, but not limited to it, a numerical scoring evaluation of the resulting question text will be analyzed for confidence 511 above a customizable percentage of correctness. In 511 this check will determine generally by means of program code if a human review in 512 of the information is needed.

If the human interactive step 512 determines correctness or incorrectness, the result will be sent by means of program code to 508 and the process will continue through the same steps between 508 and 511 until it is correct, and then it will be transferred generally by means of program code to 513 to determine if the response should be sent only through a secured messaging mechanism. If 513 determines that a secure channel must be used, it will maintain the resulting information in a data table 518. The correct mechanism to securely communicate with a unique session identifier will be set as the return result in 513. If, generally by means of program code, the request is determined to need mandatory human interaction 514 directly with the requestor, a data table entry will be created in the stored conversation record so that the requestors conversation will be directly sent to a human for further review in 521. In some embodiments, the requestor result will be evaluated by the Language Interpreter 515 to convert from English to the proper requestor language. The result be sent to a third-party language converter 519. The result may then be inserted into the caller conversation database and returned to the user in 516 through data transport by way of 107 to the user in 102.

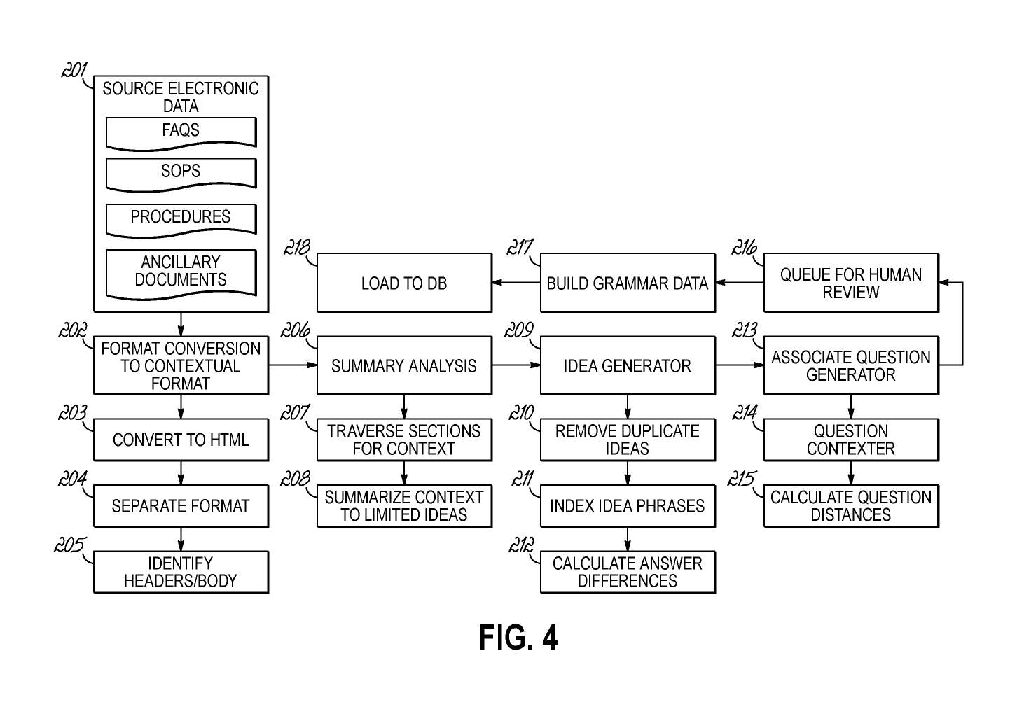

FIG. 4 provides a flowchart that illustrates a sequence of operations that may be performed by the processor starting with 202 wherein the data files in electronic form 201 are input files that can be read into memory in 202 to be converted to a normalized format such as html or xml. The files may or may not be stored on a server disk and then loaded to the program to process either in memory or from disk. Between operations 203 and 205 files are then interpreted for a unified format in html. When completed, generally by means of program code, the data is summarized, and common contexts are created and indexed. Then common ideas are reduced to summarized ideas of common sentences, phrases and indexed by word 208 and then stored to disk or memory depending on embodiment. The ideas are then computed generally by means of program code where duplicate ideas, phrases and indexes are reduced and collated. The ideas are reduced to statement phrases as answers in 211. Each phrase is compared per idea generally by means of program code in 212 to one another. Analysis of the ontology tree per phrase is calculated by distance from part of speech to see how similar the phrases are. This will create a list of possible ideas that may be similar.

The ideas, whether generally alike or very dissimilar are converted by program code in 213 to a question of how, when, where, why or what with a synset of can, will, should, could. In the question context 214, questions are associated with answers and then the associated object model is evaluated in 215 to determine how similar by word, phrase and synset distance to see if models can be combined and if there are duplicates to reduce the model size. Once calculated and created, the models generally, by means of program code, are queued to a data table for review by a human who can visually look at the models as text either temporarily stored in a data table or text file in 216. Reviewers can modify models and then approve models. Once approved in 217 generally by program code, the models are created for usage and then in 218 they are loaded to a database where they can be accessed by programs in FIG. 1 at step 105.

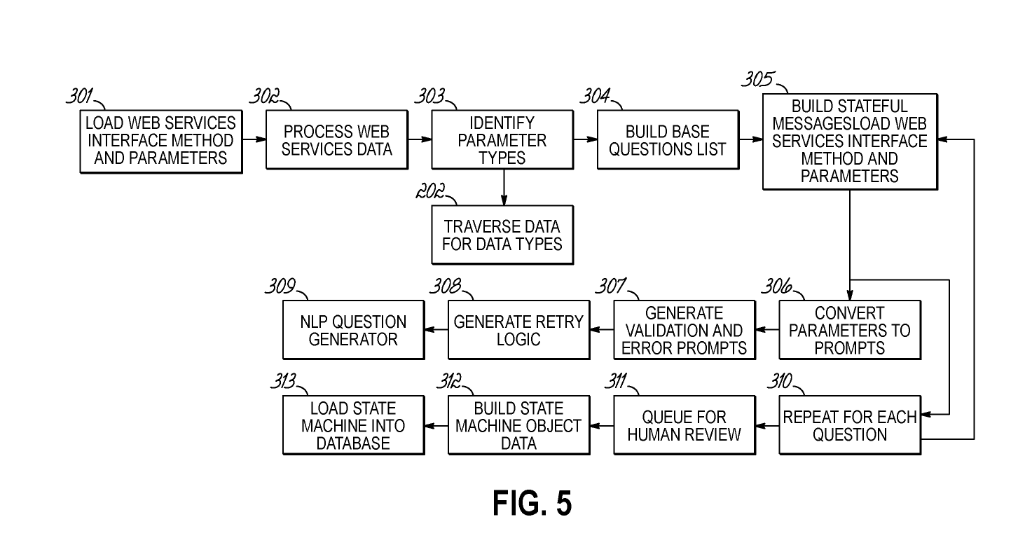

Referring now to the invention in more detail, in FIG. 5 a block diagram of an application that will load web services 301, the associated data and parameters is shown. In 302, by generally means of program code, the web service information will be broken down into different types of data associated with expected results and expected parameters that may, but is not limited to, be set up as an example or by means of running the WSDL commands and retrieving the XML metadata. The parameters generally by means of program code will be parsed out by common data types associated with the database and programming languages and then broken down into internal state machine programming types 302 as defined by the state machine's data tables 314. Next, generally by means of program code, the parameters will be analyzed by the program for priority or necessity and ordered 304. This will then convert into a static data table created in 305 where prompts are generated programmatically, and questions are associated then standardized validation based on parameter type and error prompting with prompts are ordered with retry logic 305 through 308. The program will next process the prompt text and build associated hierarchical synsets 309 that keep similar prompts for alternative comparison during runtime in FIG. 1. This process will repeat 310, 305 until all parameters are handled so that the data result can be achieved through a stateful conversation. Once this process is complete in this embodiment of the invention a human review 311 of the state machine resulting prompts, expected answers and retry logic will all be reviewed by someone who understands the web service and what questions need to be answered to get the anticipated result from the caller. Likely reviewer modifications will include question ordering and wording of questions. All modifications generally by means of program code will be compiled into indexed object data 312 that will then be loaded to the state machine as it is associated with a particular call type 313.

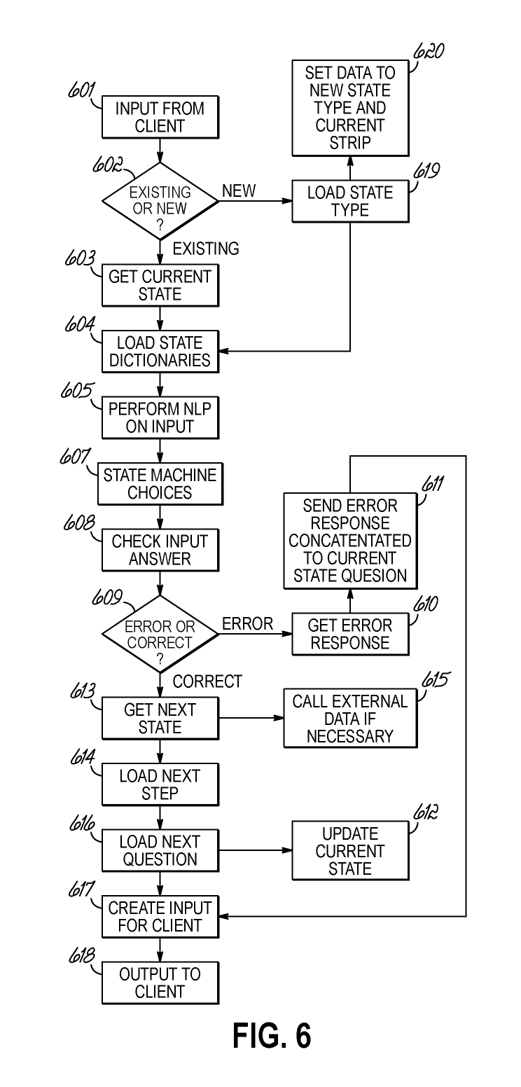

Referring now to the invention in more detail, in FIG. 6 a block diagram of a process that is generally processed by means of program code that analyzes the inbound request from FIG. 1 item 102 and if determined to be a State Machine request the process code is executed is shown. In 601 client originated input is sent to the state machine to determine if it is a new or existing state machine request 602. If existing, the process continues from where ever the current state left off at the last request to the client 603. Once the state is determined, the natural language processing dictionaries are loaded 604 for the step and then the program will process generally by means of program code with language comparison in 605. At this point the highest confidence will be determined and the processed and then State Machine Choices 607 will be loaded. The state machine will look to see which possible answer is correct based on the returned natural language processing. The input is checked in 608. If there is an error, the question will be attached to an appropriate error response in 610 and the response will be sent back to the user. If a correct possible answer is found, the next step will be set in 613 and external third-party calls may be called 613. The Next step will be set based on the answer in 614 and the next question will be loaded. The current state will be updated in 616 and loaded to the data table 615. The response will be converted to an appropriate format 617 and then output back to the client 618 for review and possible response.

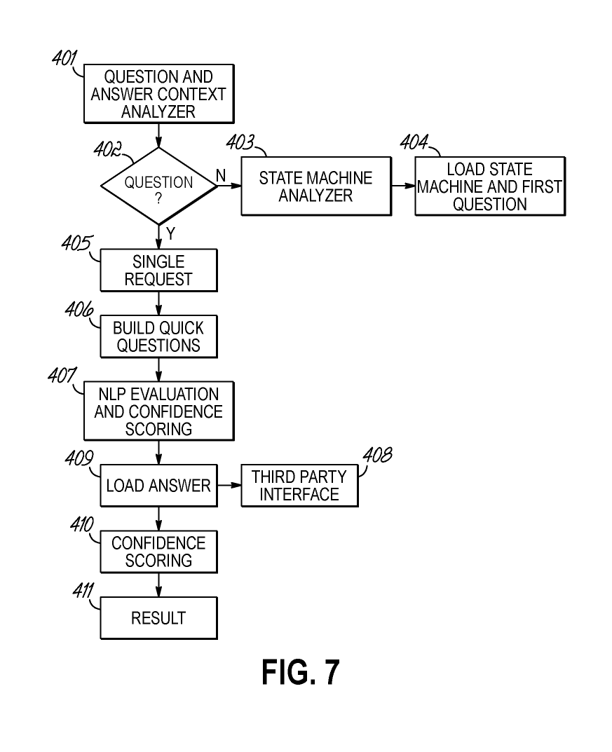

Referring now to the invention in more detail, FIG. 7 is a block diagram of a process that is generally processed by means of program code that analyzes the inbound request to determine if it is a standalone question; part of a stateful request; or, a specific command to take action. The requested input as string input to item 401 analyzes the request input structure. It does this by performing maximum entropy using a basic formula where sample data is used to build a model file where phrase combinations that form questions determine the highest probable question type.

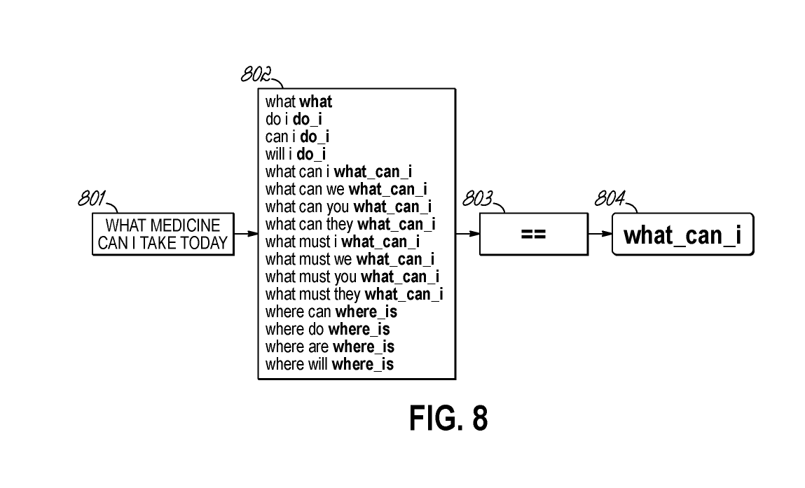

An example of this is in FIG. 8. The inbound request of “What medicine can I take today” in 801 was written without punctuation so it appears as a statement. By utilizing common modeling data 802 and determining a probability in relation to other sample question types that exist within the model, the highest possible hit closest to 801 will be returned 803. The model receiving the highest score based on identifying the highest probable number of words associated with the base answer 804 will be returned. The answers are normalized in the model. The result can then be used to normalize the highest probable question associated with the probable answers. This question would be converted to the normalized answer of “What medicine can I take today?”.

In FIG. 7, the result would return this question. This would send the question to 405 identifying that it is a question, and this is the normalized question. It would Look at an index of exact questions and see if there is a match 406 and then look at a heuristic model 407 using a natural language process. Natural Language Processes can use, but are not limited to, maximum entropy models, heuristic or bipartite graphs to find the best results. It is recommended, but not required, that multiple techniques be utilized. This embodiment uses both heuristic and maximum entropy models and compare results for reliability and scoring the result. The scores are compared. If both techniques produce the highest score, the result is returned with an average confidence score between the two. If they differ by a determined increment the higher of the two results is returned as the result as long as the score is higher than the minimal excepted threshold.

When the highest confidence results are returned multiple synchronous or asynchronous events may occur, but are not limited to these events in any sequence. A third-party service 408 may be called to return additional data or information such as information that needs to help find the appropriate answer. Once the answer is located and loaded 409, confidence scoring 410 may need some additional information from the natural language processing to help determine next steps. Once the information is collected, the result is returned to the calling process 411 and includes all the information used to determine the answer including, but not limited to, the other possible answers and the associated confidence scores.

From the above disclosure of the general principles of this invention and the preceding detailed description of at least one embodiment, those skilled in the art will readily comprehend the various modifications to which this invention is susceptible. Therefore, I desire to be limited only by the scope of the following claims and equivalents thereof.

I claim:

1. A server-based technology system comprising:
an input mechanism for bi-directional communication for making a request in the form of one of an informational request and a command-based request that will be analyzed via data modeling and natural language processing to determine a correct response with associated information and return the correct response to the input mechanism.

2. The system of claim 1 further comprising:
a server in communication with the input mechanism and which uses a state machine to manage a conversation state within a session time limit to reference previous requests and gather multiple pieces of information.

3. The system of claim 2 wherein the server uses semantic similarity to score and identify the request in combination with the previous requests to determine a mechanism for responding to the request.

4. The system of claim 2 wherein the server uses relational synsets of an ontology tree to determine a relativeness of a phrase within the request and a subset of words within the request compared to an index of phrases and relative words within the phrase compared with a data model to calculate a relative score and determine a likeliness of the phrase being most like a specific data model phrase as the result.

5. The system of claim 2 wherein the server compares stateless data model phrases to identify the correct response.

6. The system of claim 2 wherein the server uses human review to determine and finalize the correct response sent back to the input mechanism.

7. The system of claim 2 wherein the server identifies a result that requires further information from a third-party system and returns third party data and loads the third party data into a returning data model's placeholder fields.

8. The system of claim 2 wherein the server identifies a caller language and sends a language request to another program to convert the request to English so it can be analyzed as an English phrase by data modeling and natural language processing relative to the previous requests.

9. The system of claim 2 wherein the server identifies a caller's language and returns a result to another program to convert the response from English to the caller's language prior to returning the correct response to the input mechanism.

10. The system of claim 2 wherein the server data models are created by utilizing natural language processing and summarizing procedures to find ideas then build related questions to programmably form data models.

11. The system of claim 10, wherein the server utilizes human review to modify and complete data models that were created programmatically.

12. The system of claim 2 wherein a response from the server is reviewed and answered by humans to provide requisite information used to answer the request back to the system so the system can modify data models to add or remove models to handle the request without human intervention in future similar requests.

13. The system of claim 1 wherein the input mechanism further comprises text messages.

14. A method of providing a caller with a result, the method comprising:
receiving a request into a system from the caller via a mechanism as one of a question, a statement and a command;
analyzing the request to determine a language of the request;
tracking the request to see if there is a session of related information;
determining if the request is related to an existing request;
accessing dictionaries and grammar associated with an appropriate state of the request to comparatively analyze if the request has an associated response in the system;
generating a response to the request with a confidence score for the likelihood that the response is correct;
determining if the response needs to be reviewed by a human; and
sending the response to the caller via the mechanism.

15. The method of claim 14 further comprising:
querying a third-party application for more relevant information pertaining to the request; and
receiving an answer from the third-party application for more relevant information.

16. The method of claim 14 wherein the response is generated without review by the human.

17. The method of claim 14 wherein the request is in a non-English language, the method further comprising:
translating the request to English after the receiving step; and
translating the response to the non-English language before the sending step.

18. The method of claim 14 wherein the request is associated with a stateful conversation, the method further comprising:
utilizing data from a previous communication in the generating step.

19. The method of claim 14 further comprising:
determining if the request is invalid; and
indicating to the caller that the request was invalid.
